(19) United States
(12) Patent Application Publication
(10) Pub. No.: US 2013/0100063 A1
(43) Pub. Date: Apr. 25, 2013

(54) TOUCH PANEL DEVICE

(71) Applicant: Takashi Saeki, Kanagawa (JP)

(72) Inventor: Takashi Saeki, Kanagawa (JP)

(73) Assignee: PANASONIC CORPORATION, OSAKA (JP)

(21) Appl. No.: 13/806,942

(22) PCT Filed: Apr. 20, 2012
(86) PCT No.: PCT/JP2012/002759

§ 371 Date: Dec. 26, 2012

(30) Foreign Application Priority Data
Apr. 20, 2011 (JP) 2011-093737

(51) Int. Cl. G06F 3/041

(52) U.S. Cl. CPC G06F 3/041
USPC 345/173

(57) ABSTRACT

A mobile terminal 101 includes an unlocking operation detecting part 201 which detects an unlock operation from a touch panel 111, an input medium determining part 202 which determines an input medium based on contact information in an unlock operation, a contact position detecting part 203 which detects a contact position at depressing a button from the touch panel 111, an icon sensing region determining part 204 which executes an icon process determination by calculating a sensed area of an icon based on the input medium and the contact position, an icon process executing part 205 which executes a process based on the process determination, and a display output 206 which executes a display instruction with an icon process execution.

### TECHNICAL FIELD

The invention relates to a touch panel device providing an optimized user interface to a user using a touch panel.

### BACKGROUND ART

Generally, in touch panels, users have to operate button icons having predetermined fixed sizes and predetermined fixed arrangements. Also, in mobile telephones, functions thereof are continuously increased, and proportionally the number of button icons for selecting and operating on the touch panels is increased, and thus size of button icons tends to be gradually decreased. In particular, if the button icons are small, when button icons are pressed by a finger, there is a problem in that erroneous operations are likely to be occurred, thereby reducing operability.

Accordingly, Patent Document 1 describes a technique in which a sensing region of a button icon is expanded based on past data with respect to distances or directions from the center of the button icon upon pressing of the button icon, thereby improving operability when the button icon is pressed.

Also, Patent Document 2 describe a technique in which, if the number of erroneous operations upon pressing of a button icon reaches a predetermined number, a sensing region of the button icon is reduced or expanded, thereby improving operability when the button icon is pressed.

### PRIOR ART DOCUMENTS

### Patent Documents

[Patent Document 1] JP 2009-37343 A

[Patent Document 2] JP 2010-55225 A

### DISCLOSURE OF THE INVENTION

### Problems to be Solved by the Invention

However, for touch panels according to the Patent Documents 1 and 2, there is a problem in that such effects cannot be achieved if data with respect to the number of operations obtained by performing some number of button pressing operations are not accumulated.

Particularly, in the case of products, adapted to use of both of a finger and a stylus, of mobile telephones with a touch panel or mobile terminal with a touch panel, contact positions are differently spaced from the center of the button icon upon pressing of the button icon. Therefore, there is a problem in that such effects of Patent Documents 1 and 2 cannot be expected when plural types of input media can be used.

Accordingly, an object of the invention is to solve the foregoing problems and to provide a touch panel device, in which a special operation only for previously specifying an input medium, such as a finger or a stylus, or acquiring an input medium information, is not required, and sizes and positions of sensing regions of button and list icons are determined to be adapted to a user's finger or a stylus, thereby improving operability when the button and list icons are pressed.

### Means for Solving the Problems

A touch panel device according to the invention includes a configuration that a sensing region of an icon is previously expanded in one direction relative to a displayed region of the icon on a touch panel.

According to the configuration, there is provided a touch panel device, in which sizes and positions of sensing regions of icons are determined, thereby improving operability when the icons are pressed.

The touch panel device according to the invention includes a further configuration that a threshold value is previously provided, and a distance for expanding in the one direction, which is previously determined based on the threshold value, is determined.

According to the configuration, there is provided the touch panel device, in which sizes and positions of sensing regions of icons are determined, thereby improving operability when the icons are pressed.

The touch panel device according to the invention includes a further configuration that a plurality of icons are displayed, a plurality of threshold values are provided for changing a distance of expanding the sensing region depending on a gap between the icons, and when being slidingly touched by a user in one direction, any one of the threshold values is selected and the sensing region is expanded, based on a width of a sensed region of the touch.

According to the configuration, there is provided a touch panel device, in which sizes and positions of sensing regions of icons are determined, thereby improving operability when the icons are pressed.

The touch panel device according to the invention includes a further configuration that a plurality of icons are displayed, a plurality of threshold values are provided for changing a distance for expanding the sensing region depending on a gap between the icons, and when being slidingly touched by a user in one direction, any one of the threshold values is selected and the sensing region is expanded in any one direction, based on areas of a sensed start point region and a sensed end point region and a slide direction.

According to the configuration, there is provided the touch panel device, in which sizes and positions of sensing regions of icons are determined, thereby improving operability when the icons are pressed.

The touch panel device according to the invention includes a further configuration that a sensing region of an icon is previously moved in one direction relative to a displayed region of the icon on a touch panel.

According to the configuration, there is provided the touch panel device, in which sizes and positions of sensing regions of icons are determined, thereby improving operability when the icons are pressed.

The touch panel device according to the invention includes a further configuration that a threshold value is previously provided, and a distance for moving in the one direction, which is previously determined based on the threshold value, is determined.

According to the configuration, there is provided the touch panel device, in which sizes and positions of sensing regions of icons are determined, thereby improving operability when the icons are pressed.

The touch panel device according to the invention includes a further configuration that a plurality of icons are displayed, a plurality of threshold values are provided for changing a distance for moving the sensing region when a gap between the icons is not present, and when being slidingly touched by a user in one direction, any one of the threshold values is selected and the sensing region is moved, based on a width of a sensed region of the touch.

According to the configuration, there is provided the touch panel device, in which sizes and positions of sensing regions of icons are determined, thereby improving operability when the icons are pressed.

The touch panel device according to the invention includes a further configuration that a plurality of icons are displayed, a plurality of threshold values are provided for changing a distance for moving the sensing region when a gap between the icons is not present, and when being slidingly touched by a user in one direction, any one of the threshold values is selected and the sensing region is moved in any one direction, based on areas of a sensed start point region and a sensed end point region and a slide direction.

According to the configuration, there is provided a touch panel device, in which sizes and positions of sensing regions of icons are determined, thereby improving operability when the icons are pressed.

### Advantageous Effects of the Invention

According to the present invention, even if a user is not particularly conscious, a special operation only for previously assigning an input medium, such as a finger or a stylus, or acquiring an input medium information, is not required, and sizes and positions of sensing regions of button and list icons are determined to be adapted to a user's finger or a stylus, thereby improving operability when the button and list icons are pressed. Also, according to the invention, when a number of users use, for example, a rental terminal and the like, sizes and positions of sensing regions of button and list icons are determined to correspond to a finger or a stylus even if users are not particularly conscious, thereby improving operability.

### BRIEF DESCRIPTION OF THE DRAWINGS

FIG. 1 is a schematic view showing a configuration of a touch panel device according to a first embodiment of the present invention.

FIG. 2 is an exterior view showing the touch panel device according to the first embodiment of the invention.

FIG. 3 is a cross-sectional view showing a touch panel portion of the touch panel device according to the first embodiment of the invention.

FIG. 4 is a view showing a distribution of contact points when a button is pressed, according to the first embodiment of the invention.

FIG. 5(a) is an explanatory view showing a slide operation according to the first embodiment of the invention, and FIG. 5(b) is an explanatory view showing a trace line width in the slide operation according to the first embodiment of the invention.

FIG. 6 is a flow chart showing an unlocking operation process of the touch panel device according to the first embodiment of the invention.

FIG. 7 is a flow chart showing a contact operation process of the touch panel device according to the first embodiment of the invention.

FIG. 8 is a flow chart showing a process for calculating a sensing region of icons in a display screen by an input medium according to the first embodiment of the invention.

FIG. 9(a) is a view showing a button icon sensing region when a gap is not present according to the first embodiment of the invention, and FIG. 9(b) is a view showing a list icon sensing region when the gap is not present according to the first embodiment of the invention.

FIG. 10(a) is a view showing a button icon sensing region when the gap is sufficiently present according to the first embodiment of the invention, and FIG. 10(b) is a view showing a button icon sensing region when the gap is not sufficiently present according to the first embodiment of the invention.

FIG. 11 is a schematic view showing a configuration of a touch panel device according to a second embodiment of the present invention.

FIG. 12 is an explanatory view showing contact areas of start and end points according to the second embodiment of the invention.

FIG. 13 is a flow chart showing an unlocking operation process of the touch panel device according to the second embodiment of the invention.

FIG. 14 is a flow chart showing a process for identifying a hand operating the touch panel device according to the second embodiment of the invention.

FIG. 15 is a flow chart showing a contact operation process of the touch panel device according to the second embodiment of the invention.

FIG. 16 is a flow chart showing a process for calculating a sensing region of icons in a display screen by an operating hand according to the second embodiment of the invention.

FIG. 17 is a view showing a button icon sensing region when a gap is not present according to the second embodiment of the invention.

FIG. 18(a) is a view showing a button icon sensing region when the gap is sufficiently present according to the second embodiment of the invention, and FIG. 18(b) is a view showing a button icon sensing region when the gap is not sufficiently present according to the second embodiment of the invention.

### MODE FOR CARRYING OUT THE INVENTION

Embodiments for implementing the present invention will be now described in detail with reference to the accompanying drawings. Meanwhile, throughout the drawings for describing the embodiments, identical reference numerals designate identical elements, and the detailed descriptions thereof will not be repeated.

### First Embodiment

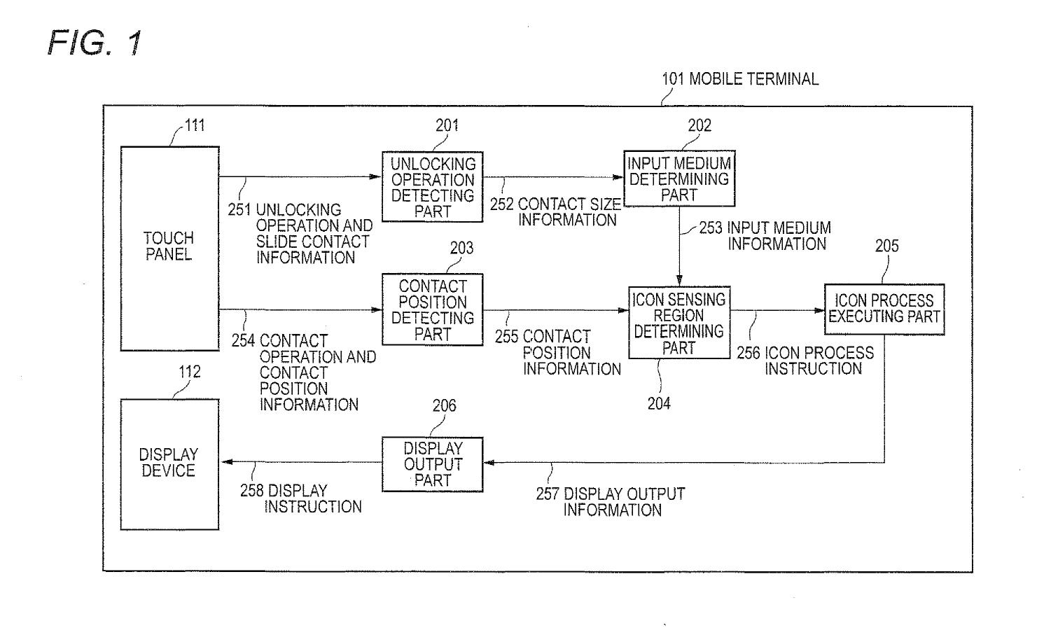

FIG. 1 is a schematic view showing a configuration of a touch panel device according to a first embodiment of the present invention. In FIG. 1, a mobile terminal 101 includes a touch panel 111, a display device 112, an unlocking operation detecting part 201, an input medium determining part 202, a contact position detecting part 203, an icon sensing region determining part 204, an icon process executing part 205 and a display output 206.

The unlocking operation detecting part 201 acquires an unlocking operation and slide contact information 251 from the touch panel 111. As used herein, the term “unlocking” means cancellation of an invalid input state for preventing an erroneous input in the touch panel. The term “slide contact information” means information of coordinates, at which a user contacts on the touch panel 111, and the like. When the unlocking operation detecting part 201 determines such information as an unlocking operation, the unlocking operation detecting part 201 outputs contact size information 252 to the input medium determining part 202. Meanwhile, the unlocking operation detecting part 201 may also have a function of acquiring the contact size information 252 by detecting an up-down slide operation and an oblique slide operation, as well as a left-right slide operation, and in addition, may also have a function of detecting a slide operation on a touch pad belonged to the touch panel device.

The input medium determining part 202 determines an input medium, such as a hand finger or a stylus, from the contact size information 252, and then outputs input medium information 253 to the icon sensing region determining part 204.

The contact position detecting part 203 acquires a contact operation and contact position information 254 from the touch panel 111, and then outputs contact position information 255 to the icon sensing region determining part 204.

The icon sensing region determining part 204 calculates a sensing region of each of displayed button icons and list icons, based on the input medium information 253. When the contact position information 255 is within the sensing region of each of button icons and list icons, the icon sensing region determining part 204 outputs an icon process instruction 256 to the icon process executing part 205 to execute a function assigned to the corresponding icon. As used herein, the phrase “sensing region of each of button icons and list icons” means a pressed position region in which, when attempting to execute a function assigned to a displayed icon, the function of the icon can be executed independently of a region displaying the icon although the icon is pressed by a finger or a stylus.

The icon process executing part 205 outputs display output information 257 to the display output 206.

The display output 206 outputs the contents of the display output information 257 as a display instruction 258 to the display device 112.

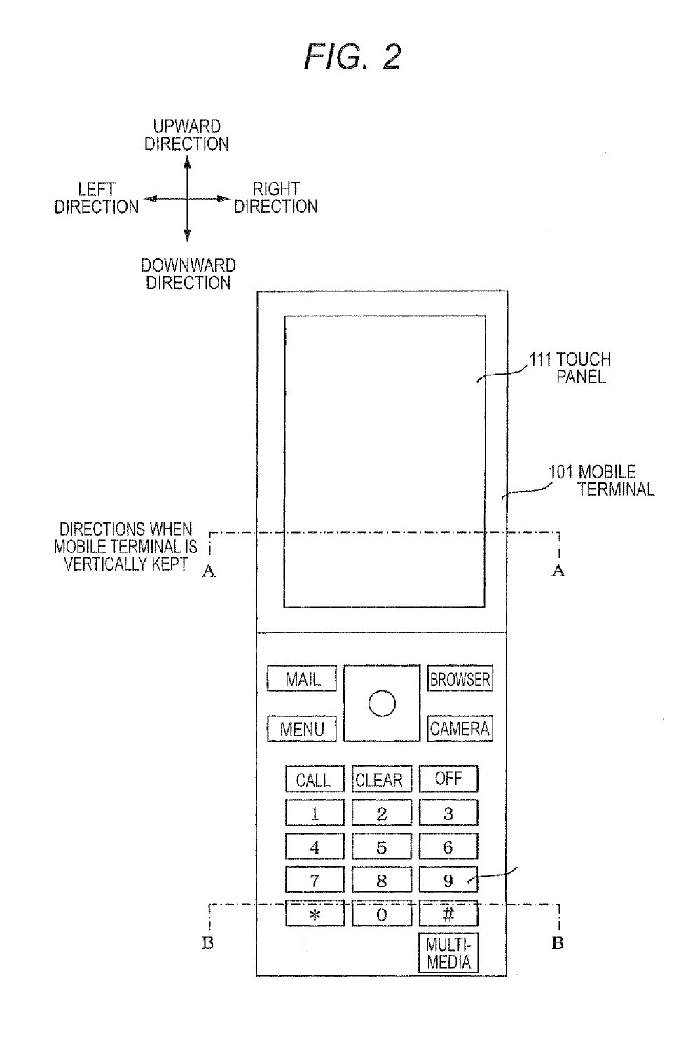

FIG. 2 is an exterior view showing the touch panel device according to the first embodiment of the invention. The touch panel 111 and a key 114 are belonged to the mobile terminal 101.

The following description will be described based on directions when the mobile terminal 101 is vertically kept, as indicated by directional arrows in FIG. 2.

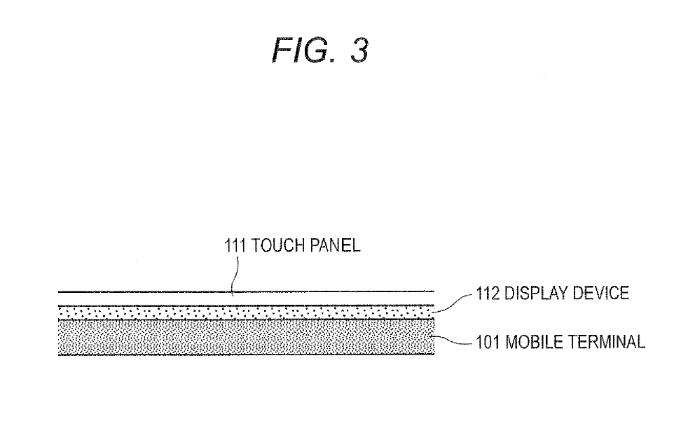

FIG. 3 is a cross-sectional view of a touch panel portion of the touch panel device according to the first embodiment of the invention, showing a section at A in FIG. 2. The touch panel 11 and the display device 112 are belonged to the mobile terminal 101.

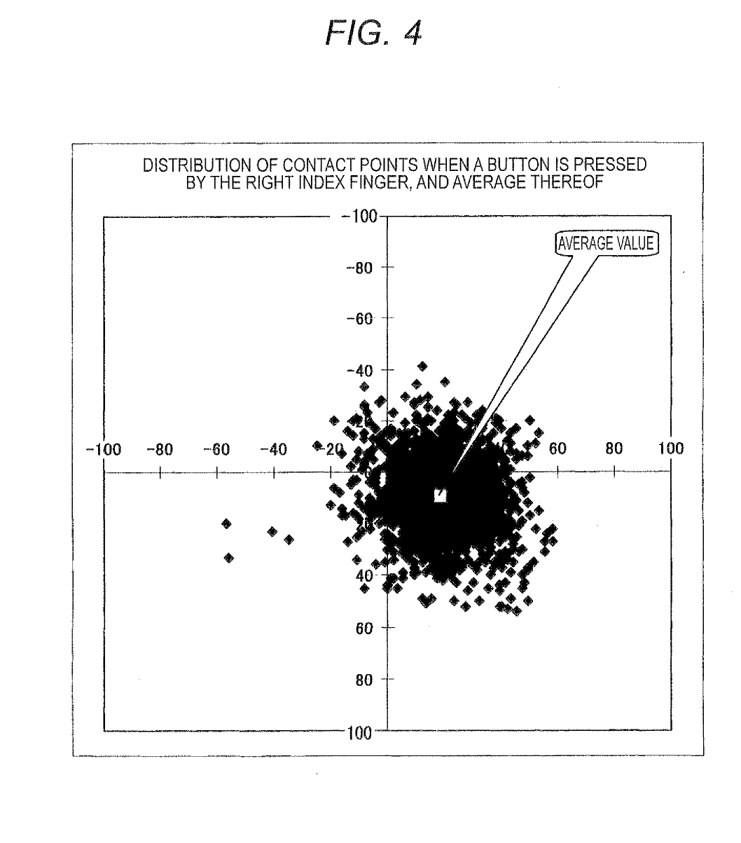

FIG. 4 is a view showing a distribution of contact points when a button is pressed, according to the first embodiment of the invention.

Approximately 2,000 data are obtained by making a few ten persons to be tested press a button icon displayed on the touch panel 111 of the mobile terminal 101 using their right index fingers. FIG. 4 shows the distribution of contact points from the center point of the button icon on the average. In general, when pressing the button by the finger, the contact points tend to be distributed downwardly from the center point of the button icon, and also because being pressed by the right hand, the contact points tend to be distributed on the right side from the center point of the button icon.

In other words, if the sensing region of button icons and list icons is downwardly moved or expanded, erroneous operations can be reduced, thereby improving operability. In addition, if the sensing region is moved or expanded in a direction of the operating hand (i.e., a right direction for the right hand and a left direction for the left hand), erroneous operations can be reduced, thereby improving operability

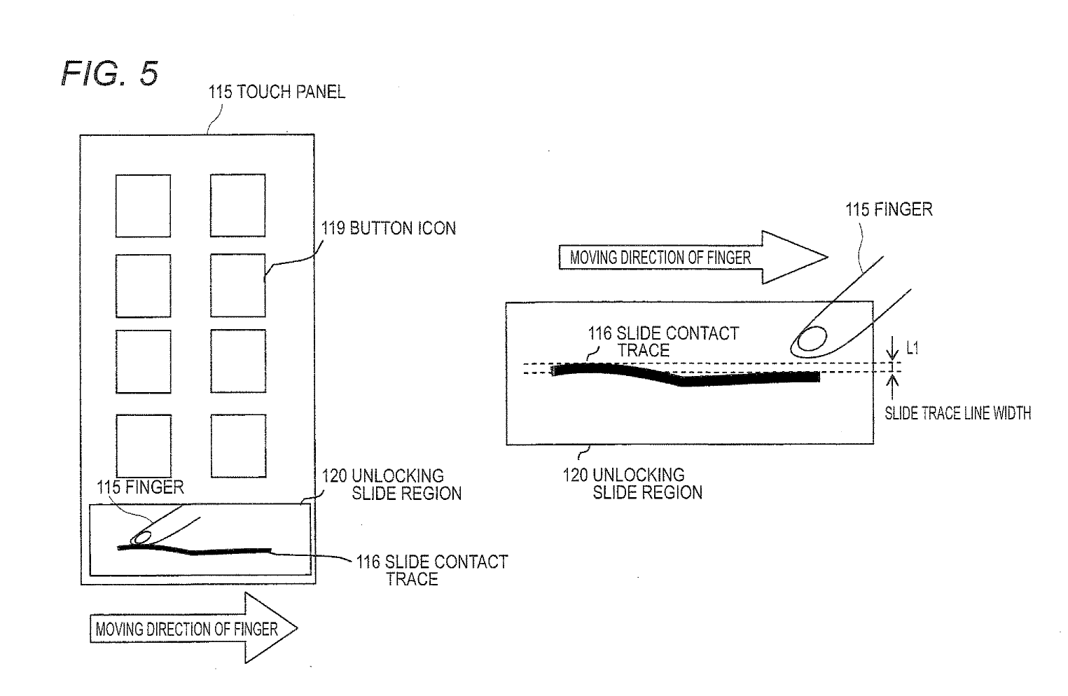

FIG. 5(a) is an explanatory view showing a slide operation according to the first embodiment of the invention.

Unlocking is performed by sliding a finger 115 on an unlocking slid region 120 of the touch panel 111 in a traversal direction (i.e., a left-right direction in the mobile terminal 101), thereby performing unlocking. A slide contact trace 116 is a trace along which the finger 115 is slid in the traversal direction.

FIG. 5(b) is an explanatory view showing a trace line width in the slide operation according to the first embodiment of the invention.

A slide trace line width L1 is a line width of the slide contact trace 116, and becomes the contact size information 252.

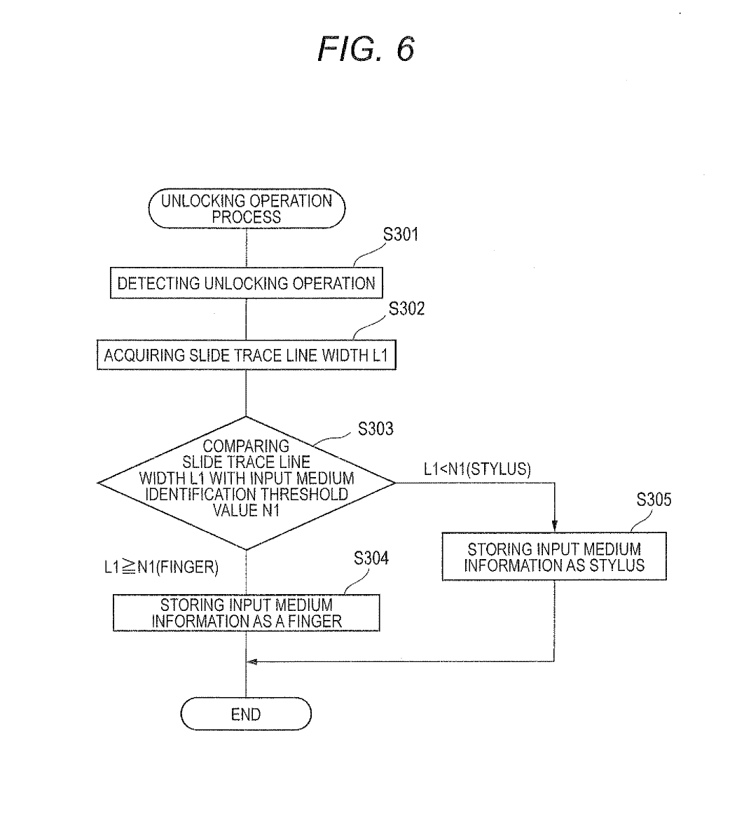

FIG. 6 is a flow chart showing an unlocking operation process of the touch panel device (the mobile terminal 101) according to the first embodiment of the invention. Hereinafter, the process will be described with reference to the figure.

When the unlocking operation detecting part 201 acquires the unlocking operation and slide contact information 251 from the touch panel 111 (S301), the unlocking operation detecting part 201 acquires the slide trace line width L1 from the unlocking operation and slide contact information 251, and thus outputs the contact size information 252 (S302).

The input medium determining part 202 determines from the contact size information 252 whether the slide contact trace is obtained by a finger operation or a stylus operation (S303). In this case, an input medium identification threshold value N1 is previously prepared as an indicator for determining whether by a finger operation or a stylus operation. The input medium identification threshold value N1 is determined by actual measurement data, such as a specification of the touch panel and a large number of persons. If the slide trace line width L1 is less than the input medium identification threshold value N1 (L1<N1), the input medium determining part 202 determines that the slide contact trace is obtained by a stylus operation, and thus the input medium information 253 indicating that the input medium is a stylus is kept as an internal data (S304). if the slide trace line width L1 is equal to or more than the input medium identification threshold value N1 (L1≧N1), the input medium determining part 202 determines that the slide contact trace is obtained by a finger operation, and thus the input medium information 253 indicating that the input medium is a finger is kept as an internal data (S305).

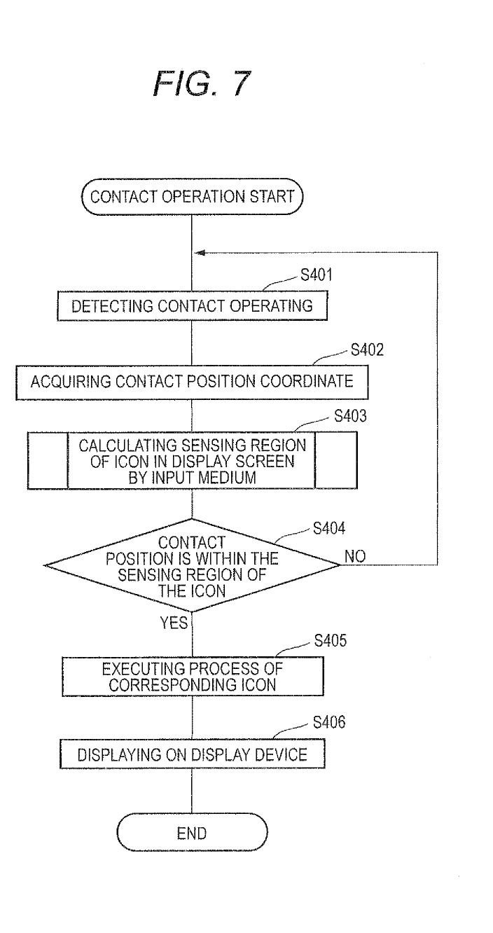

FIG. 7 is a flow chart showing a contact operation process of the touch panel device according to the first embodiment of the invention. The contact operation process for an icon on the touch panel 111 will be described with reference to FIG. 7.

The contact position detecting part 203 acquires the contact operation and contact position information 254 from the touch panel 111 (S401). The contact position detecting part 203 acquires a contact position coordinate from the contact operation and contact position information 254 (S402), and then outputs the contact position information 255 to the icon sensing region determining part 204.

The icon sensing region determining part 204 calculates sensing regions of all of button icons and list icons displayed in the display screen, from the contact position information 255 and the input medium information 253 (S403). The detailed process thereof will be described below.

Also, the icon sensing region determining part 204 determines whether the contact position is within the sensing region of icons or not (S404), and if out of the sensing region, waits the next contact operation (S401). If within the sensing region, the icon sensing region determining part 204 outputs the icon process instruction 256 to the icon process executing part 205.

The icon process executing part 205 executes a function of an icon corresponding to the contact position, based on the icon process instruction 256 (S405), and then outputs the display output information 257 to the display output 206. The display output 206 instructs the display instruction 258 to the display device 112 (S406). Specifically, the display output 206 instructs the display device 112 to change a displayed shape of the icon, to display a new icon and the like.

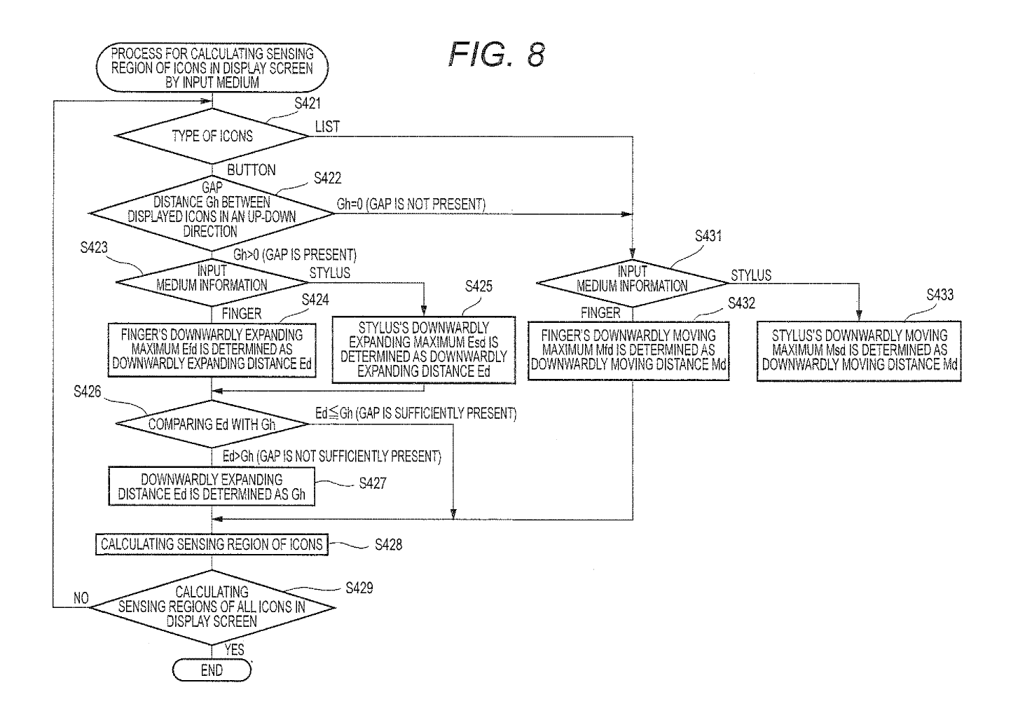

FIG. 8 is a flow chart showing a process for calculating a sensing region of icons in a display screen by an input medium according to the first embodiment of the invention. The process for calculating such an icon sensing region in the display screen will be described with reference to FIG. 8.

Firstly, a case, in which the icons are button icons 119, will be described. The icon sensing region determining part 204 identifies a type of icons (hereinafter, referred to as “displayed icons”) displayed in the display screen (S421), and if the displayed icons are the button icons 119, determines whether a gap between the displayed icons in an up-down direction is present or not (S422). Here, a gap distance between the displayed icons in the up-down direction is designated as Gh. If the gap distance is not present (Gh=0), the sensing region of the icon in the display screen is moved, and if the gap distance is present (Gh>0), the sensing region is expanded.

Then, the icon sensing region determining part 204 identifies the input medium from the input medium information 253 (S423). When the input medium is a finger, the icon sensing region determining part 204 stores a downwardly expanding distance Ed as a finger's downwardly expanding maximum Efd (S424).

Here, the downwardly expanding distance Ed is a distance by which the sensing region for the displayed button icons 119 is downwardly expanded. Also, the finger's downwardly expanding maximum Efd is a maximum value of a distance downwardly expanding the icon sensing region for the displayed button icons 119 upon operation of the finger. The finger's downwardly expanding maximum Efd is determined by actual measurement data, such as a specification of the touch panel and a large number of persons.

When the input medium is a stylus, the icon sensing region determining part 204 stores the downwardly expanding distance Ed as a stylus's downwardly expanding maximum Esd (S425).

Here, the stylus's downwardly expanding maximum Esd is a maximum value of a distance downwardly expanding the sensing region for the displayed button icons 119 upon operation of the stylus. Esd is determined by actual measurement data, such as a specification of the touch panel and a large number of persons.

Subsequently, the icon sensing region determining part 204 determines whether the downwardly expanding distance Ed corresponds to the gap between the displayed icons in the up-down direction (S426). If the gap is not sufficiently present (Ed>Gh), it is impossible to expand the sensing region by an amount corresponding to the downwardly expanding distance Ed, and thus the downwardly expanding distance Ed is kept as the gap distance Gh between the displayed icons in the up-down direction (S427). If the gap is sufficiently present (Ed≦Gh), the downwardly expanding distance Ed is used as it is. Meanwhile, when performing moving or expanding of the sensing region, the icon sensing region determining part 204 may previously change a set-up thereof to move or expand the sensing region in an upward, left or right direction, in addition to the downward direction.

The icon sensing region determining part 204 calculates and stores the sensing region for one icon, based on the downwardly expanding distance Ed (S428). Also, the icon sensing region determining part 204 determines whether calculations of the sensing regions of all icons in the display screen are ended, and repeats the forgoing process until calculations of the sensing regions of all icons in the display screen are ended (S429). Once being ended for all icons, the process for calculating a sensing region of icons in a display screen by an input medium according to the first embodiment of the invention is ended.

Next, a case, in which a type of the displayed icons is list icons 125, will be described. When the icon sensing region determining 204 determines a type of the displayed icons as the list icons 125, the sensing region cannot be expanded, and thus must be moved.

The input medium determining part 202 identifies the input medium, based on the input medium information 253 (S431). When the input medium is a finger, the icon sensing region determining part 204 stores a downwardly moving distance Md as a finger's downwardly moving maximum Mfd (S432). If the input medium is a stylus, the downwardly moving distance Md is kept as a stylus's downwardly moving maximum Msd.

Here, the stylus's downwardly moving maximum Msd is a maximum value of a distance downwardly moving the sensing region for the displayed button and list icons upon operation of the stylus. The stylus's downwardly moving maximum Msd is determined by actual measurement data, such as a specification of the touch panel and a large number of persons.

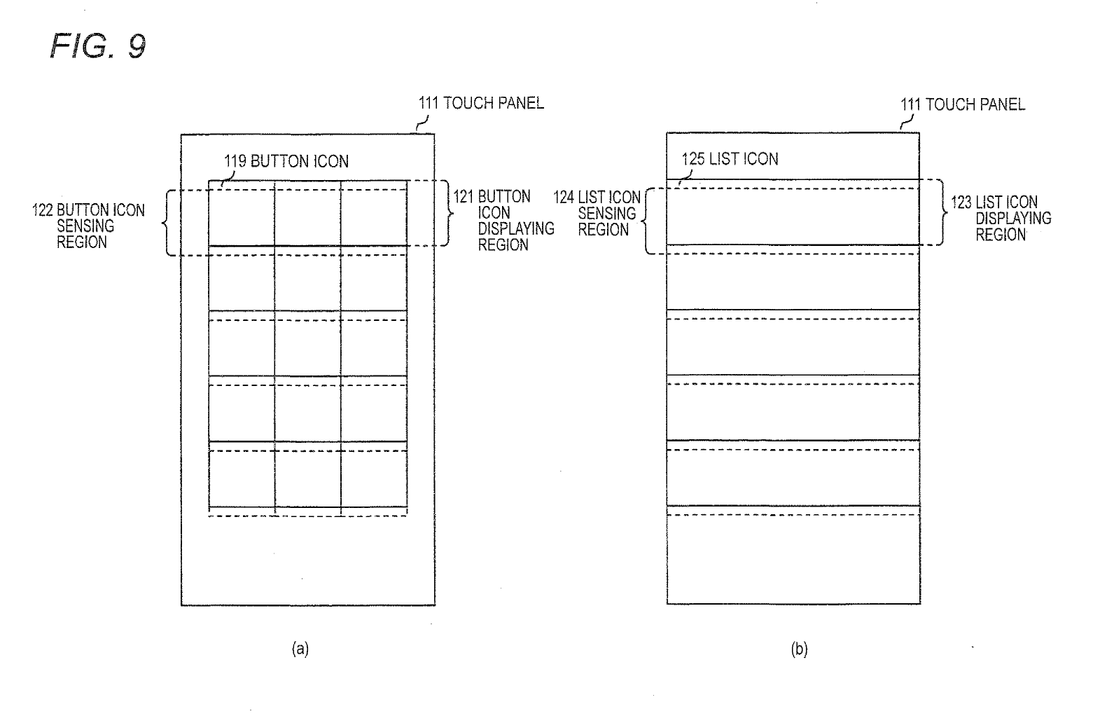

FIG. 9(a) is a view showing a button icon sensing region when the gap is not present according to the first embodiment of the invention.

The button icons 119 are displayed on the touch panel 111. The button icon sensing region 122 corresponds to a button icon display region 121 downwardly moved.

FIG. 9(b) is a view showing a list icon sensing region when the gap is not present according to the first embodiment of the invention.

The list icons 125 are displayed on the touch panel 111. The list icon sensing region 124 corresponds to a list icon display region 121 downwardly moved.

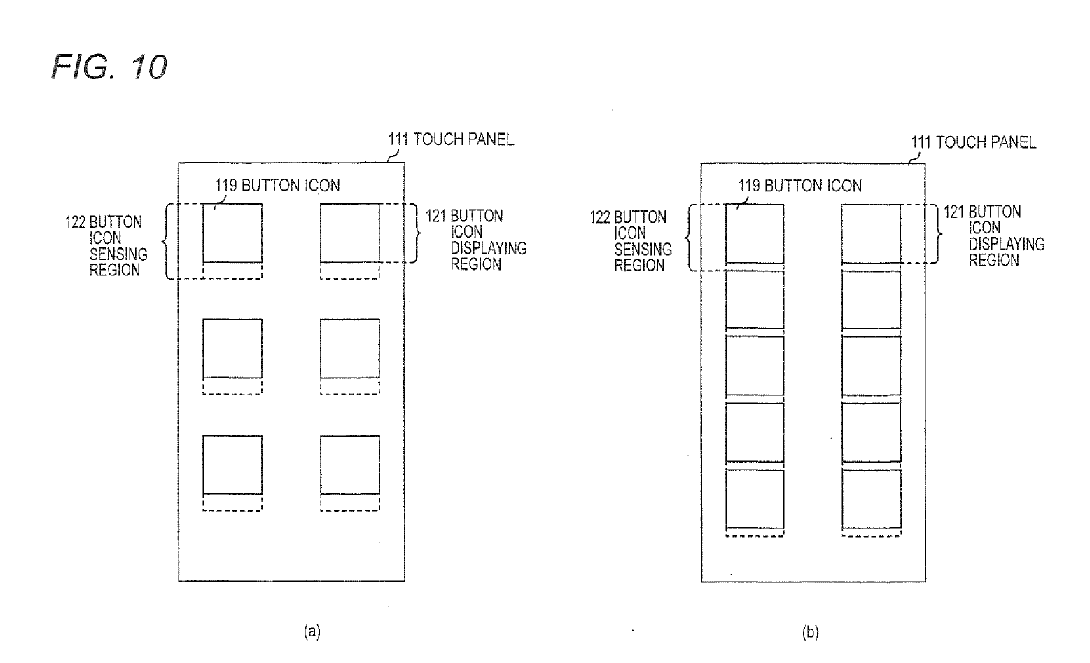

FIG. 10(a) is a view showing the button icon sensing region when the gap is sufficiently present according to the first embodiment of the invention.

The button icons 119 are displayed on the touch panel 111. The button icon sensing region 122 corresponds to the button icon display region 121 downwardly expanded.

FIG. 10(b) is a view showing the button icon sensing region when the gap is not sufficiently present according to the first embodiment of the invention. The button icons 119 are displayed on the touch panel 111. The button icon sensing region 122 corresponds to the button icon display region 121 downwardly expanded. The gaps between the button icons in the up-down direction all become the sensing regions.

Also, the icon sensing region determining part 204 may have a function of calculating sensing regions of other icons, such as scroll bars, in addition to button icons and list icons, and determining an icon function thereof.

Further, when performing moving or expanding of the sensing region, the icon sensing region determining part 204 may have a function of performing moving and expanding of the sensing region by acquiring information set by a user with respect to whether moving or expanding in each of downward, upward, left and right directions is present or not.

Furthermore, when performing moving or expanding of the sensing region, the icon sensing region determining part 204 may have a function of performing moving and expanding of the sensing region by acquiring a maximum value set by a user with respect to moving or expanding of a finger or a stylus in each of directions.

Furthermore, when simultaneously performing expanding of the sensing region in both downward and upward directions, the icon sensing region determining part 204 may have a function of calculating a ratio of expanding distances in downward and upward directions, if maximum values of the expanding distances in each of downward and upward directions cannot be acquired.

In addition, when simultaneously performing expanding of the sensing region in both left and right directions, the icon sensing region determining part 204 may have a function of calculating a ratio of expanding distances in left and right directions, if maximum values of the expanding distances in each of left and right directions cannot be acquired.

As described above, the mobile terminal 101 according to the first embodiment of the present invention includes the unlocking operation detecting part 201, the input medium determining part 202, the contact position detecting part 203, the icon sensing region determining part 204, the icon process executing part 205 and the display output 206, and determines sizes and positions of sensing regions of button and list icons corresponding to an input medium, such as a finger or a stylus, from an unlocking slide operation which a user is not particularly conscious, thereby improving operability.

### Second Embodiment

Next, a second embodiment of the present invention will be described. The second embodiment of the invention is characterized in that a hand (i.e., the right hand or left hand) performing an unlocking operation can be identified, compared to the first embodiment as described above.

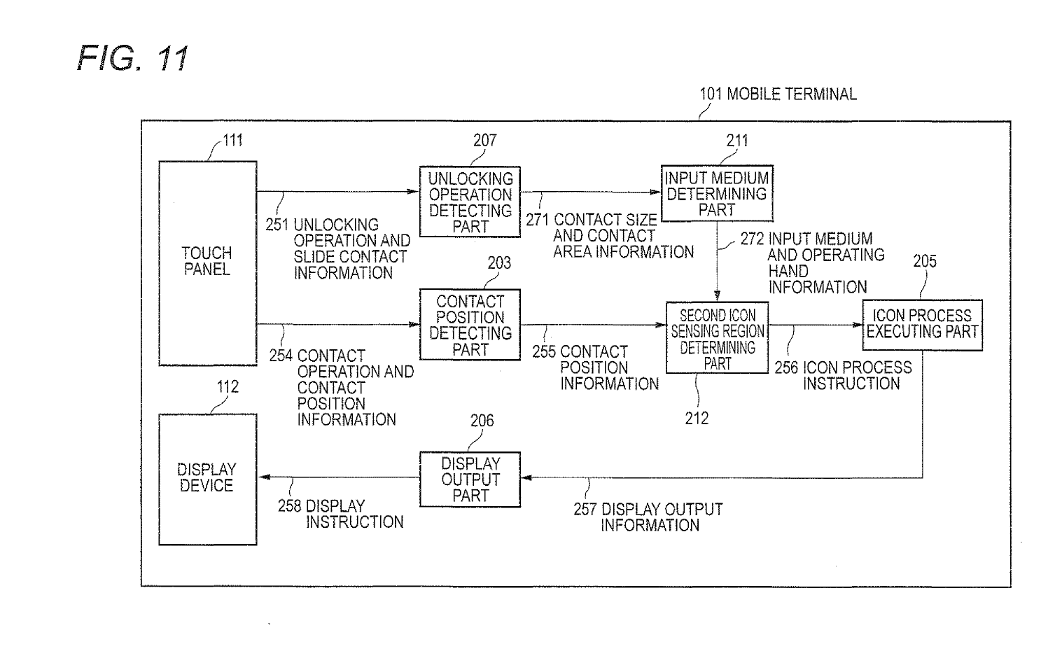

FIG. 11 is a schematic view showing a configuration of a touch panel device according to a second embodiment of the present invention. In FIG. 11, a mobile terminal 101 includes a touch panel 111, a display device 112, an unlocking operation detecting part 207, an input medium determining part 211, a contact position detecting part 203, a second icon sensing region determining part 212, an icon process executing part 205, and a display output 206.

The unlocking operation detecting part 207 acquires an unlocking operation and slide contact information 251 from the touch panel 111. When the unlocking operation detecting part 207 determines an input operation to the touch panel 111 as an unlocking operation, based on the unlocking operation and slide contact information 251, the unlocking operation detecting part 207 outputs contact size and contact area information 271 to the input medium determining part 211.

The input medium determining part 211 determines an input medium, such as a finger or a stylus, and also determines which of hands is an operating hand, from the contact size and contact area information 271, and then outputs input medium and operating hand information 272 to the second icon sensing region determining part 212.

The contact position detecting part 203 acquires a contact operation and contact position information 254 from the touch panel 111, and then outputs contact position information 255 to the second icon sensing region determining part 212.

The second icon sensing region determining part 212 calculates a sensing region of each of displayed button icons and list icons, based on input medium and operating hand information 272. When the contact position information 255 is within the sensing region of each of button icons and list icons, the second icon sensing region determining part 212 outputs an icon process instruction 256 to the icon process executing part 205 to execute a function assigned to the corresponding icon.

The icon process executing part 205 outputs display output information 257 to the display output 206.

The display output 206 outputs the contents of the display output information 257 as a display instruction 258 to the display device 112.

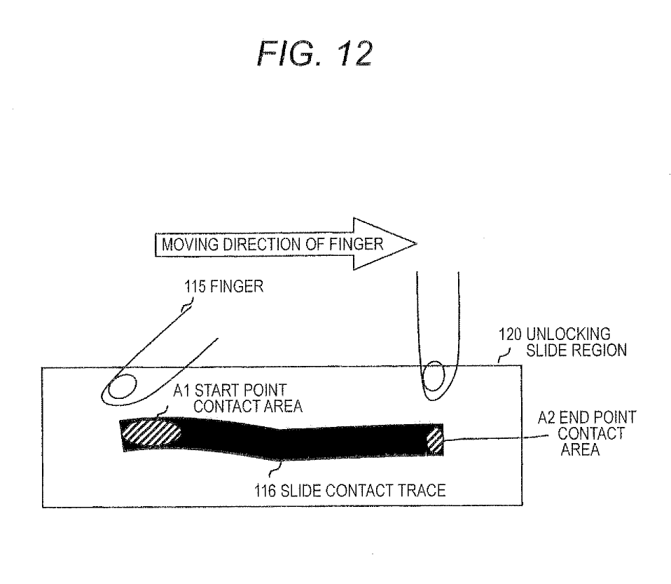

FIG. 12 is an explanatory view showing contact areas of start and end points according to the second embodiment of the invention.

Unlocking is performed by sliding finger 115 on an unlocking slid region 120 in a traversal direction (i.e., a left-right direction in the mobile terminal). A slide contact trace 116 is a trace along which the finger 115 is slid in the traversal direction. A start point contact area A1 and an end point contact area A2 each are contact areas of the finger with the touch panel upon starting and ending of the slide operation, respectively. is When the mobile terminal is held by one hand and the holding thumb is used for an operation of pressing an icon on the touch panel and the like, a contact area of the thumb is varied depending on locations on the touch panel 111, because the thumb has a short length. FIG. 12 shows when the mobile terminal is vertically held by the right hand and the right hand thumb is used for such an operation. When touching a left side of the touch panel 11, the contact area of the right hand thumb is increased. Contrarily, when touching a right side of the touch panel 111, the contact area of the right hand thumb is decreased because the right hand thumb becomes into an upright state, compared to the case of touching the left side. If a significant difference between contact areas of the start and end points is present, the operating hand (the right hand or left hand) can be identified. If the sensing region is moved or expanded in a direction of the operating hand (i.e., a right direction for the right hand and a left direction for the left hand), erroneous operations can be reduced, thereby improving operability

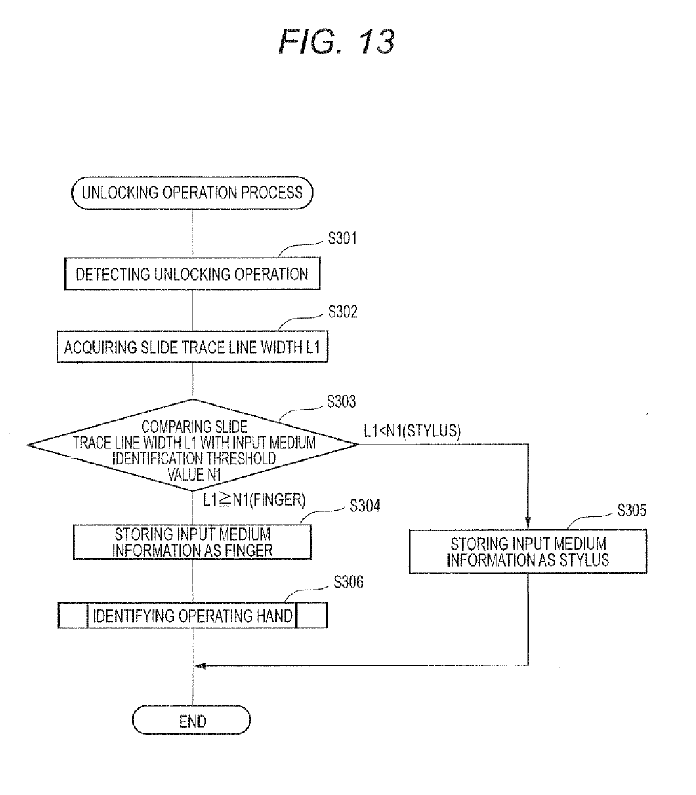

FIG. 13 is a flow chart showing an unlocking operation process of the touch panel device according to the second embodiment of the invention. Hereinafter, the process will be described with reference to the figure.

When the unlocking operation detecting part 207 acquires the unlocking operation and slide contact information 251 from the touch panel 111 (S301), the unlocking operation detecting part 207 acquires the slide trace line width L1 from the unlocking operation and slide contact information 251, and thus outputs the contact size and contact area information 271 (S302).

The input medium determining part 211 determines from the contact size and contact area information 271 whether the slide contact trace is obtained by a finger operation or a stylus operation (S303). If the slide trace line width L1 is less than the input medium identification threshold value N1 (L1<N1), the input medium determining part 211 determines that the slide contact trace is obtained by a stylus operation, and thus the input medium and operating hand information 272 indicating that the input medium is a stylus is kept as an internal data (S304).

If the slide trace line width L1 is equal to or more than the input medium identification threshold value N1 (L1≧N1), the input medium determining part 211 determines that the slide contact trace is obtained by a finger operation, and thus the input medium and operating hand information 272 indicating that the input medium is a finger is kept as an internal data (S305).

When the input medium is a finger, the input medium determining part 211 identifies an operating hand from the input medium and operating hand information 272 (S306). The detailed process thereof will be described below.

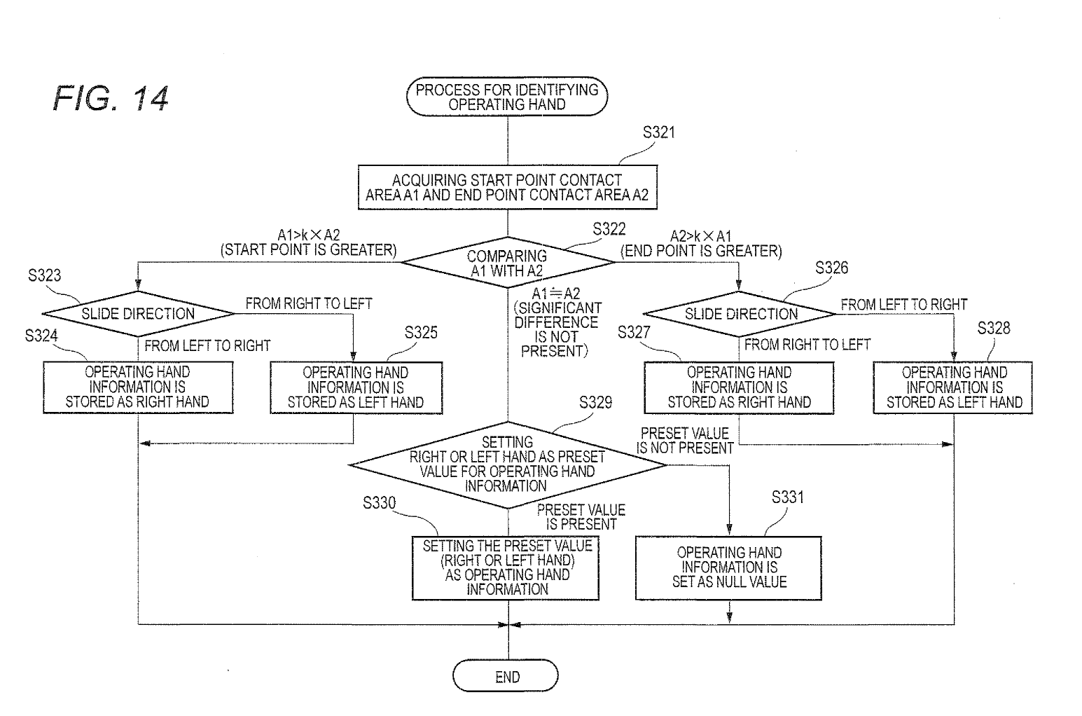

FIG. 14 is a flow chart showing a process for identifying a hand operating the touch panel device according to the second embodiment of the invention. The process for identifying such an operating hand contacted on an icon on the touch panel will be described with reference to FIG. 14.

The input medium determining part 211 acquires the start point contact area A1 and the end point contact area A2 from the unlocking operation detecting part 207 (S321).

Also, the input medium determining part 21 compares the start point contact area A1 with the end point contact area A2 (S322). In this case, a proportional constant k is provided for comparing between the contact areas. The proportional constant k is a threshold value used for identifying differences between operating hands, when comparing the start point contact area A1 with the end point contact area A2. The proportional constant k is determined by actual measurement data, such as a specification of the touch panel 111 and a large number of persons. For each of a case in which the start point contact area A1 is greater (A1>k×A2), a case in which the end point contact area A 2 is greater (A2>k×A1), and the other case, i.e., a case in which a significant difference is not present between the start point contact area A1 and the end point contact area A2 (A1≈A2), different processes are performed.

When the start point contact area A1 is greater(A1>k×A2), the input medium determining part 211 identifies a slide operation direction (S323). The input medium determining part 21 can identify the slide operation direction from the contact size and contact area information 271.

The input medium determining part 211 stores the operating hand as the right hand, when the slide operation direction is from left to right (S324). The input medium determining part 211 stores the operating hand as the left hand, when the slide operation direction is from right to left (S325).

When the end point contact area A2 is greater (A2>k×A1), the input medium determining part 211 identifies a slide operation direction (S326). The input medium determining part 211 stores the operating hand as the right hand, when the slide operation direction is from right to left (S327). The input medium determining part 211 stores the operating hand as the left hand, when the slide operation direction is from left to right (S328).

When the start point contact area A1 and the end point contact area A2 are approximated to each other (A1≈A2), the input medium determining part 211 identifies the operating hand from a preset value for the operating hand (S329). When the preset value for the operating hand is present, the input medium determining part 211 stores the preset value for the operating hand set by a user as information with respect to the operating hand (S330). If the preset value for the operating hand is not present, the input medium determining part 211 stores a null value as information with respect to the operating hand (S331).

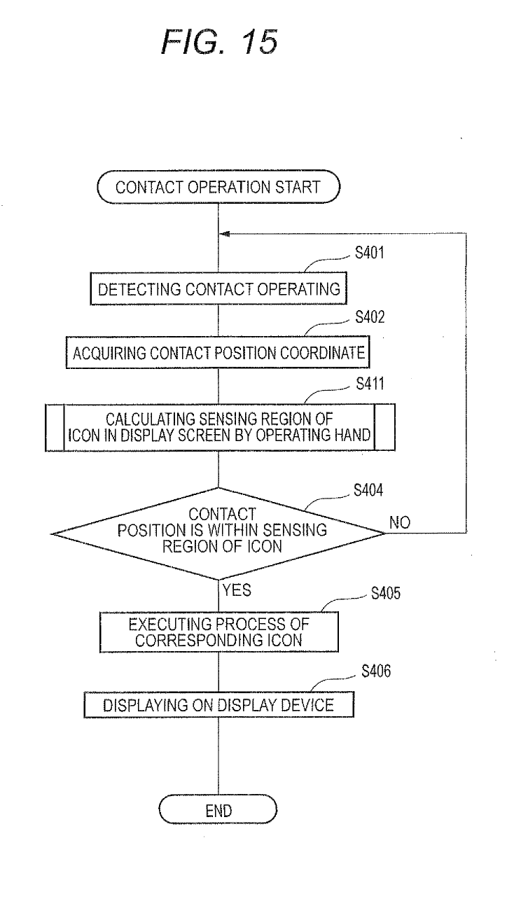

FIG. 15 is a flow chart showing a contact operation process of the touch panel device according to the second embodiment of the invention. The contact operation process for an icon on the touch panel will be described with reference to FIG. 11.

The contact position detecting part 203 acquires the contact operation and contact position information 254 from the touch panel 111 (S401). The contact position detecting part 203 acquires a contact position coordinate from the contact operation and contact position information 254 (S402), and then outputs the contact position information 255 to the second icon sensing region determining part 212.

The second icon sensing region determining part 212 calculates sensing regions of all of button icons and list icons displayed in the display screen, from the contact position information 255 and the input medium and operating hand information 272 (S411). The detailed process thereof will be described below.

Also, the second icon sensing region determining part 212 determines whether the contact position on the touch panel 111 is within the sensing region of icons or not (S404), and if out of the sensing region, waits the next contact operation (S401). If within the sensing region, the second icon sensing region determining part 212 outputs the icon process instruction 256 to the icon process executing part 205.

The icon process executing part 205 executes a function of an icon corresponding to the contact position, based on the icon process instruction 256 (S405), and then outputs the display output information 257 to the display output 206.

The display output 206 instructs the display instruction 258 to the is display device 112 (S406). Specifically, the display output 206 instructs the display device 112 to change a displayed shape of the icon, to display a new icon and the like.

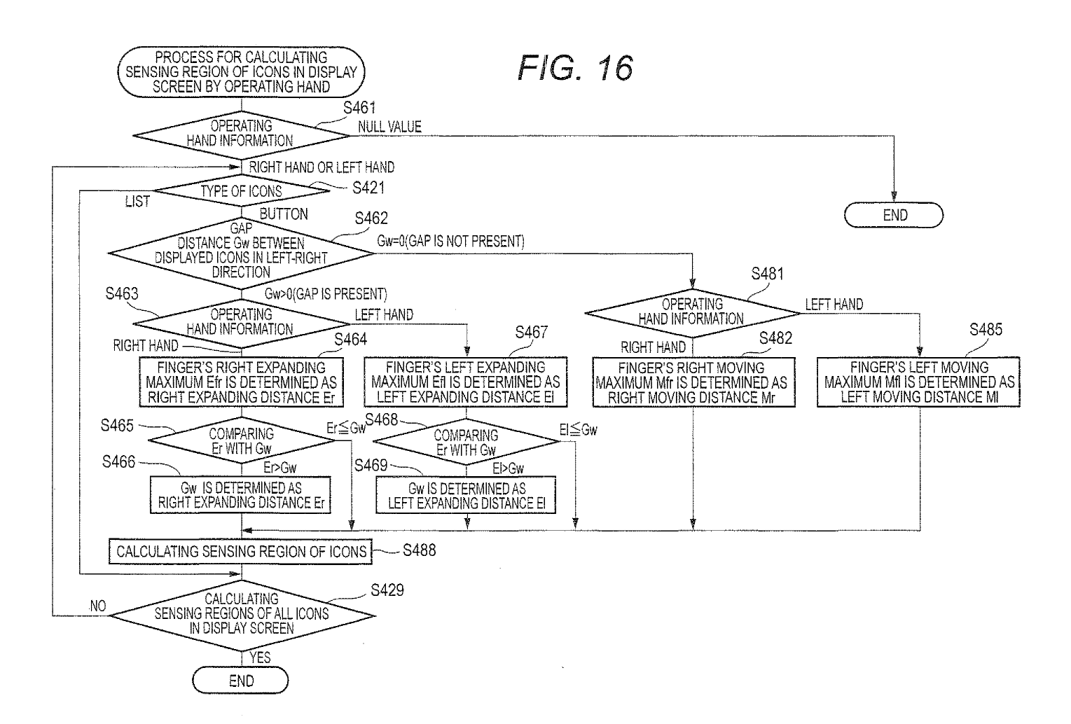

FIG. 16 is a flow chart showing a process for calculating a sensing region of icons in a display screen by an operating hand according to the second embodiment of the invention. The process for calculating such an icon sensing region in the display screen will be described with reference to FIG. 16.

The second icon sensing region determining part 212 identifies an operating hand from the input medium and operating hand information 272 (S461). When the operating hand information is a null value, moving and expanding of the icon sensing region is not performed, and thus the process for calculating a sensing region of icons in a display screen by an input medium according to the first embodiment of the invention is ended.

When the operating hand information is the right or left hand, the second icon sensing region determining part 212 identifies a type of displayed icons (S421). For list icons, moving and expanding of the sensing region by the operating hand is not performed.

For button icons, the second icon sensing region determining part 212 determines whether a gap between the displayed icons in a left-right direction is present or not (S462). Here, a gap distance between the displayed icons in the left-right direction is designated as Gw. If the gap distance is not present (Gw=0), the sensing region of the icon in the display screen is moved, and if the gap distance is present (Gw>0), the sensing region is expanded.

Then, the second icon sensing region determining part 212 identifies the operating hand from the input medium and operating hand information 272 (S463). When the operating hand information is the right hand, the second icon sensing region determining part 212 stores a right expanding distance Er as a finger's right expanding maximum Efr (S464).

Here, the right expanding distance Er is a distance by which the sensing region for the displayed button icons 119 is expanded in a right direction. Also, the finger's right expanding maximum Efr is a maximum value of a distance expanding the icon sensing region for the displayed button icons 119 in a right direction upon operation of the finger. Efr is determined by actual measurement data, such as a specification of the touch panel 111 and a large number of persons.

The second icon sensing region determining part 211 determines whether the right expanding distance Er corresponds to the gap between the displayed icons in the left-right direction (S465). If the gap is sufficiently present (Er≦Gw), the second icon sensing region determining part 212 stores the right expanding distance Er as it is. If the gap is not sufficiently present (Er>Gw), the second icon sensing region determining part 212 cannot expand the sensing region by an amount corresponding to the right expanding distance Er, and thus the right expanding distance Er is kept as the gap distance Gw between the displayed icons in the left-right direction (S466).

If the operating hand information is the left hand, the second icon sensing region determining part 212 stores a left expanding distance El as a finger's left expanding maximum Efl (S467).

Here, the left expanding distance El is a distance by which the sensing region for the displayed button icons 119 is expanded in a left direction. Also, the finger's left expanding maximum Efl is a maximum value of a distance expanding the icon sensing region for the displayed button icons 119 in a left direction upon operation of the finger. Efl is determined by actual measurement data, such as a specification of the touch panel 111 and a large number of persons.

The second icon sensing region determining part 211 determines whether the left expanding distance El corresponds to the gap between the displayed icons in the left-right direction (S468). If the gap is sufficiently present (El≦Gw), the second icon sensing region determining part 212 stores the left expanding distance El as it is. If the gap is not sufficiently present (El>Gw), the second icon sensing region determining part 212 cannot expand the sensing region by an amount corresponding to the left expanding distance El, and thus the left expanding distance El is kept as the gap distance Gw between the displayed icons in the left-right direction (S469).

Next, the second icon sensing region determining part 212 identifies the operating hand from the input medium and operating hand information 272 (S481).

When the operating hand information is the right hand, a right moving distance Mr is kept as a finger's right moving maximum Mfr.

Here, the right moving distance Mr is a distance by which the sensing region for the displayed button icons 119 is moved in a right direction. Also, the finger's right moving maximum Mfr is a maximum value of a distance moving the icon sensing region for the displayed button icons 119 in a right direction upon operation of the finger. Mfr is determined by actual measurement data, such as a specification of the touch panel 111 and a large number of persons.

When the operating hand information is the left hand, a left moving distance Ml is kept as a finger's left moving maximum Mfl.

Here, the left moving distance Ml is a distance by which the sensing region for the displayed button icons 119 is moved in a left direction. Also, the finger's left moving maximum Mfl is a maximum value of a distance moving the icon sensing region for the displayed button icons 119 in a left direction upon operation of the finger. Mfl is determined by actual measurement data, such as a specification of the touch panel 111 and a large number of persons.

The second icon sensing region determining part 212 calculates and stores the sensing region for one icon (S488).

Also, the second icon sensing region determining part 212 determines whether calculations of the sensing regions of all icons in the display screen are completed (S429). If being not completed, a type of the next displayed icons is identified. If being completed for all icons, the process for calculating a sensing region of icons in a display screen by an operating hand according to the second embodiment of the invention is ended.

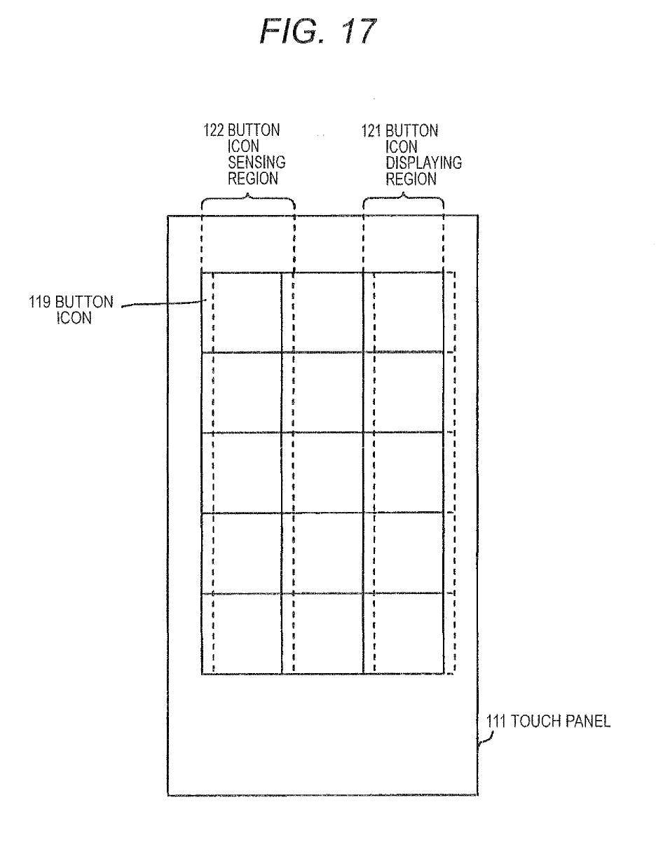

FIG. 17 is a view showing a button icon sensing region when a gap is not present according to the second embodiment of the invention. The button icons 119 are displayed on the touch panel 111. The button icon sensing region 122 corresponds to a button icon display region 121 moved in a right direction.

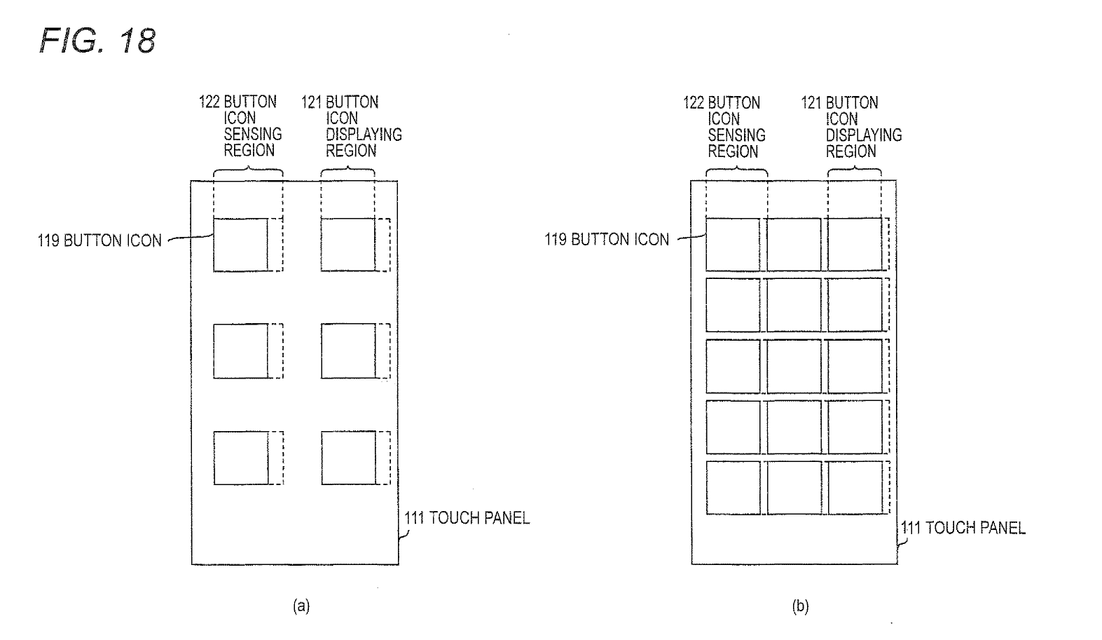

FIG. 18(a) is a view showing a button icon sensing region when the gap is sufficiently present according to the second embodiment of the invention. The button icons 119 are displayed on the touch panel 111. The button icon sensing region 122 corresponds to a button icon display region 121 expanded in the right direction.

FIG. 18(b) is a view showing a button icon sensing region when the gap is not sufficiently present according to the second embodiment of the invention. The button icons 119 are displayed on the touch panel 111. The button icon sensing region 122 corresponds to the button icon display region 121 expanded in the right direction. The gaps between the button icons in the left-right direction all become the sensing regions.

Also, according to the embodiment, the unlocking operation detecting part 207 may have a function of acquiring the contact size and contact area information 271 by detecting an up-down slide operation and an oblique slide operation, in addition to such a left-right slide operation.

Further, according to the embodiment, the unlocking operation detecting part 207 may have a function of detecting a slide operation on a touch pad belonged to the touch panel device.

Furthermore, according to the embodiment, the second icon sensing region determining part 212 may have a function of calculating sensing regions of other icons, such as scroll bars, in addition to button icons and list icons, and determining an icon function thereof.

Furthermore, according to the embodiment, when performing moving or expanding of the sensing region, the second icon sensing region determining part 212 may have a function of performing moving and expanding of the sensing region in an upward or downward direction, in addition to the left-right direction.

Furthermore, according to the embodiment, when performing moving or expanding of the sensing region, the second icon sensing region determining part 212 may have a function of performing moving and expanding of the sensing region by acquiring information set by a user with respect to whether moving or expanding in each of downward, upward, left and right directions is present or not.

Furthermore, according to the embodiment, when performing moving or expanding of the sensing region, the second icon sensing region determining part 212 may have a function of performing moving and expanding of the sensing region by acquiring a maximum value set by a user with respect to moving or expanding of a finger in each of directions.

Furthermore, according to the embodiment, when simultaneously performing expanding of the sensing region in both left and right directions, the second icon sensing region determining part 212 may have a function of calculating a ratio of expanding distances in left and right directions, if maximum values of the expanding distances in each of left and right directions cannot be acquired.

Furthermore, according to the embodiment, when simultaneously performing expanding of the sensing region in both downward and upward directions, the second icon sensing region determining part 212 may have a function of calculating a ratio of expanding distances in downward and upward directions, if maximum values of the expanding distances in each of downward and upward directions cannot be acquired.

In addition, the embodiment may be used in combination with moving or expanding of the sensing region by the input medium according to the first embodiment.

As described above, the mobile terminal 101 according to the second embedment of the present invention includes the unlocking operation detecting part 207, the input medium determining part 211, the contact position detecting part 203, the second icon sensing region determining part 212, the icon process executing part 205 and the display output 206, and determines sizes and positions of sensing regions of button and list icons corresponding to an operating hand, such as the right hand or left hand, from an unlocking slide operation which a user is not particularly conscious, thereby improving operability.

This application is based on Japanese Patent Application (Japanese Patent Application No. 2011-093737) filed on Apr. 20, 2011, the entire contents of which are incorporated herein by reference.

### INDUSTRIAL APPLICABILITY

The present invention is characterized in that a region in which a touch by a user can be sensed can be expanded in one direction relative to a displaying region associated with a region touched by the user, and is useful for an input device having a touch panel.

### DESCRIPTION OF REFERENCE NUMERALS AND SIGNS

101 Mobile terminal
111 Touch panel
112 Display device
114 Key
115 Finger
116 Slide contact trace
119 Button icons
120 Unlocking slid region
201, 207 Unlocking operation detecting part
202, 211 Input medium determining part
203 Contact position detecting part
204 Icon sensing region determining part
205 Icon function executing part
206 Display output
212 Second icon sensing region determining part
251 Unlocking operation and slide contact information
252 Contact size information
253 Input medium information
254 Contact operation and contact position information
255 Contact position information
256 Icon process instruction
257 Display output information
258 Display instruction
271 Contact size and contact area information
272 Input medium and operating hand information
L1 Slide trace line width
A1 Start point contact area
A2 End point contact area

1-8. (canceled)

9. A touch panel device, wherein a sensing region of an icon is expanded in one direction by a predetermined distance with respect to a displayed region in which a plurality of icons are displayed on a touch panel, based on any one of a plurality of threshold values for changing the distance of expanding the sensing region of the icon depending on a predetermined gap between the icons in response to a width of a sensed region when being slidingly touched in one direction by a user.

10. A touch panel device, wherein a sensing region of an icon is expanded in any one direction by a predetermined distance with respect to a displayed region in which a plurality of icons are displayed on a touch panel, based on any one of a plurality of threshold values for changing the distance of expanding the sensing region of the icon depending on a predetermined gap between the icons in response to areas of a sensed start point region and a sensed end point region and a slide direction when being slidingly touched in one direction by a user.

11. A touch panel device, wherein a sensing region of an icon is moved in one direction by a predetermined distance with respect to a displayed region in which a plurality of icons are displayed on a touch panel, based on any one of a plurality of threshold values for changing the distance of moving the sensing region when there is no predetermined gap between the icons which is selected in response to a width of a sensed region when being slidingly touched in one direction by a user.

12. A touch panel device, wherein a sensing region of an icon is moved in any one direction by a predetermined distance with respect to a displayed region in which a plurality of icons are displayed on a touch panel, based on any one of a plurality of threshold values for changing the distance of moving the sensing region when there is no predetermined gap between the icons which is selected in response to areas of a sensed start point region and a sensed end point region and a slide direction when being slidingly touched in one direction by a user.
